(19) United States
(12) Patent Application Publication
(10) Pub. No.: US 2001/0011943 A1
(43) Pub. Date: Aug. 9, 2001

(54) Apparatus for activating and/or deactivating a security device

(76) Inventors: Hans-Peter Lassle, Usingen (DE); Dietmar Schmid, Villmar (DE)

Correspondence Address: Martin A. Farber, Suite 473, 866 United Nations Plaza, New York, NY, 10017, US

(21) Appl. No.: 09/727,368

(22) Filed: Nov. 29, 2000

(30) Foreign Application Priority Data
Mar. 12, 1999 (DE) 199 58 145.2

(51) Int. Cl. H04Q 1/00

(52) U.S. Cl. 340/5.72; 340/10.1

(57) ABSTRACT

The invention relates to an apparatus for activating and/or deactivating a security device, particularly an entry device for a motor vehicle, having a portable transmitter unit for transmitting a coded information item which is received by a receiver apparatus and is compared with a prescribed coded information item, the receiver apparatus being capable of outputting an actuation signal to the security device if the two information items match.

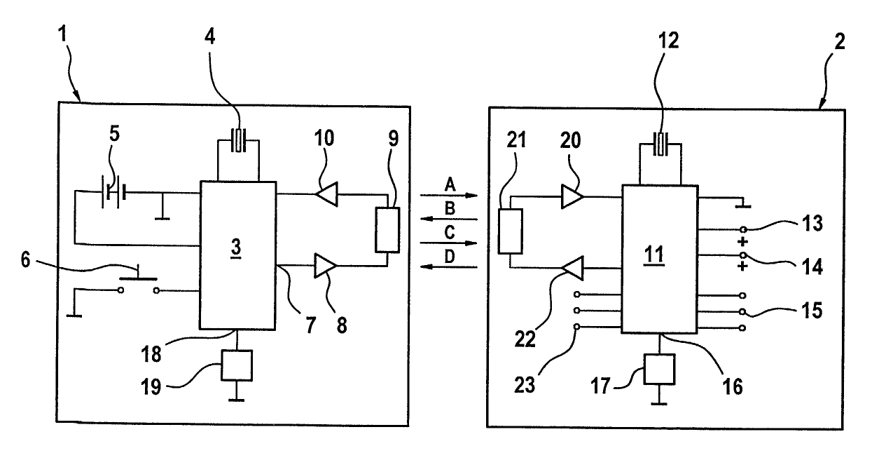

In an apparatus which operates reliably and with security against tapping, even in the event of interference on the transmission link, to set up a two-way data transmission link, the portable transmitter unit (1) emits a stimulus sequence (A) which, once received by the receiver device (2), is answered with a response signal (B), and, having received the response signal (B), the portable transmitter unit (1) transmits the coded information item (C).

The invention relates to an apparatus for activating and/or deactivating a security device, particularly an entry device for a motor vehicle, having a portable transmitter unit for transmitting a coded information item which is received by a receiver apparatus and is compared with a prescribed coded information item, the receiver apparatus being capable of outputting an actuation signal to the security device if the two information items match.

Known apparatuses for activating and/or deactivating a locking system in a motor vehicle have a portable transmitter which, on request, transmits a coded information item to a receiver device which is permanently installed in the motor vehicle. The receiver device compares the transmitted coded information item with an information item which is generated in it. If the two information items match, the locking system is actuated by the receiver device.

To ensure that only quite specific transmitters are able to unlock or lock a central locking system, the transmission protocols are provided with an allocation. This allocation comprises a fixed code and an alternating code.

To calculate the respective next alternating code values, the same algorithm is used in the transmitter and in the receiver. In this context, the receiver has a so-called capture range for unlocking and locking, said capture range always permitting a plurality of future coded information items as being valid. The alternating code is changed in the transmitter by request; in the receiver, on the other hand, it is equated to that of the transmitter when a valid information item is received. Hence, if a plurality of coded information items from the transmitter do not reach the receiver, a permissible coded information item may be outside the capture range of the receiver and may not be recognized by the receiver.

Particularly when radio remote controls are used, where coded information items are transported over long ranges using a radio signal, interference within the transmission link may impair or completely interrupt the receiver's reception of the coded information item transmitted by the transmitter.

If, in addition, an information item not received by the receiver is successfully tapped, recorded and used to open the motor vehicle without authorization, reliable operation of the security device is not ensured.

The invention is thus based on the object of specifying an apparatus for activating and/or deactivating a security device which operates reliably and with security against tapping even when there is interference with the transmission link.

The invention achieves the object by virtue of the feature that, to set up a two-way data transmission link, the portable transmitter unit emits a stimulus sequence which, once received by the receiver device, is answered with a response signal, and, having received the response signal, the portable transmitter unit transmits the coded information item.

Setting up a two-way radio link first activates the transmitter and the receiver and prepares them for transmission and reception of a coded information item. The actual interchange does not take place until imminent transmission of a coded information item has been detected both by the transmitter and by the receiver, however.

The particular advantage of the invention is that the data transmission link is set up by uncoded signal elements. If these signals are tapped, they cannot be used to activate or deactivate the security device.

If, when the two-way radio link is being set up, an interference signal prevents the receiver from receiving the stimulus sequence, the coded information item is not transmitted, because the response signal has not been transmitted.

Advantageously, the stimulus sequence, the response signal and the coded information item are transmitted in approximately the same frequency range, which means that only one transceiver unit is required in the transmitter and in the receiver.

In one development of the invention, the portable transmitter unit and the receiver apparatus each contain a code generator, the first code generator in the portable transmitter unit generating the coded information item which is to be transmitted, and the second code generator in the receiver apparatus generating the prescribed coded information item, both code generators operating on the basis of the same algorithm. In this context, one or more respective random numbers which are independent of one another may be used as code, said random numbers being processed and compared with one another in the receiver on the basis of particular arithmetic rules.

In one particularly simple embodiment, the algorithm is used for repeatedly modifying the coded information item which is to be transmitted and the prescribed coded information item. The algorithm and the number of its applications can be chosen such that the next coding to be used cannot be calculated with the coded information items picked up previously before a new random number is used.

As an alternative to this, the algorithm for modifying the coded information items which are to be transmitted and the prescribed coded information items can be changed after each action by the portable transmitter unit.

The system's security against tapping is increased further by virtue of the fact that the first and second code generators advance the coded information item which is to be transmitted and the prescribed coded information under time control. In this context, the clock rate for the first code generator in the portable transmitter unit must be chosen to be higher than the clock rate for the second code generator in the receiver device, in order to ensure that the coded information items transmitted by the portable transmitter unit are always regarded by the receiver apparatus as being in the future so that they can be reliably recognized as permissible codings.

To prevent the capture range of the receiver apparatus from being exceeded by the coded information item in the portable transmitter unit after a particular time, the first and second code generators are set to a common value after the actuation signal is output by the receiver device.

Should the data transmission link between the portable transmitter unit and the receiver be subject to interference, then, if an acknowledgment signal from the receiver device confirming receipt of the coded information item fails to appear, the first code generator in the portable transmitter unit is advanced. If the coded information item which is to be transmitted fails to appear despite transmission of the response signal the second code generator in the receiver apparatus is likewise advanced.

This has the advantage that the interruption in the data link can be detected both by the transmitter unit and by the receiver. In the case of the receiver apparatus, a data connection has been set up, but no coded information item has been received. In the case of the portable transmitter unit, a data connection has been set up, but no response signal about receipt of the stimulus sequence has been received.

In one advantageous embodiment, the first and second code generators are advanced by the same number of steps. Since both devices are advanced, the apparatus remains in operation, i.e. the recorded protocols are shifted into the past and newly transmitted coded information items are regarded by the receiver as being in the future and can thus be permitted for activating or deactivating the security device.

The invention supports numerous embodiments. One of these will be explained with the aid of the FIGURE shown in the drawing.

The portable transmitter unit 1 contains a microcomputer 3 having an associated quartz oscillator 4 for clock signal generation. The power supply used is a battery 5 which is in the form of a button cell in order to achieve a small physical size for the apparatus. A pushbutton switch 6 is used to turn on the transmitter apparatus. Over the input 18 the microcomputer 3 is additionally connected to a random number generator 19.

The output 7 of the microcomputer 3 is connected to an antenna 9 via an amplifier 8 for the purpose of transmitting radio signals. For receiving radio signals, the antenna 9 is connected to the microcomputer 3 via a further amplifier 10. The receiver apparatus 2 likewise has a microcomputer 11 having a quartz oscillator 12. The connection 13 is used to connect the microcomputer 11 to the motor vehicle's power source (terminal 13). The connection 14 is connected to the motor vehicle's ignition switch (terminal 15), so that the microcomputer 11 is actuated with each starting procedure. The inputs 15 of the microcomputer 11 are respectively associated with a locking apparatus arranged in a door of the motor vehicle and can be used to actuate the microcomputer 11 as a result of mechanical operation using a key when normal operation of the control apparatus is disrupted. Connected to a further input 16 of the microcomputer 11, there is likewise a generator 17 generating a random pulse train. A transmission/reception antenna 21 is connected to the microprocessor 11 via the amplifiers 20 and 22. Each of the three connections 23 of the microcomputer 11 is connected to the locking apparatus in the motor vehicle's central locking system and transmits the actuation signal output by the microcomputer 11.

The coded information item is formed using a fixed code and an alternating code. The alternating code is generated using the random number generated by the random number generator 19, 17 and using the algorithm stored in the microprocessor. The value of the alternating code is changed in the portable transmitter unit 1 by a particular event, e.g. whenever the pushbutton switch 6 has been operated.

In the receiver device 2, the values of the alternating code are split into permissible and impermissible values. In this context, the permissible values are always in the future and the impermissible values are always in the present and in the past. The dividing line between these ranges is determined by the current value of the alternating code and by the capture range, the current value corresponding to the present and the capture range corresponding to a prescribed number of future information items among the coded information items which are to be transmitted.

The device operates as follows:

Operating the pushbutton switch 6 gives the microcomputer 3 in the portable transmitter unit 1 the instruction to start the algorithm for generating a random number, with the random number being supplied by the generator 19. At the same time, a stimulus sequence A is transmitted to the receiver 2 in the motor vehicle via the antenna 9 independently of the algorithm. This stimulus sequence A is detected by the antenna 21 and is passed on to the microprocessor 11, which likewise activates the algorithm in the microprocessor 11 and the generation of the random number by the random number generator 17.

In response to the stimulus sequence A being received, a response signal 5 is transmitted to the portable transmitter 2 via the antenna 21. Both the stimulus sequence A and the response signal B are unrelated to the actual coded information item.

Once the microprocessor 3 in the portable transmitter 1 has received the response signal B, it transmits the coded information item generated in the meantime using the algorithm and the random number to the receiver 2. The microprocessor 11 in the receiver 2 assesses the received coded information item C by comparing it with a coded information item which has been formed using the random number generated by the random number generator 17. In this case, the same algorithm has been used as is used in the microprocessor 3 in the portable transmitter unit 2. If the transmitted, coded information item and the coded information item generated in the receiver itself match, the microprocessor 11 outputs an acknowledgment signal D to the transmitter 1 via the antenna 21. At the same time, if the coded information items match, the connections 23 are activated by the microprocessor 11 and the connected central locking system or an immobilizer in the motor vehicle are put into the desired state.

If the portable transmitter unit 1 receives the acknowledgment signal D, the microprocessor 3 knows that the receiver 2 has received the coded information item. When activation next occurs as a result of the pushbutton switch 6 being operated, the algorithm can be advanced in order thus to calculate a new random code.

Alternatively, it is also possible for the algorithm which is used to form the coded information items in the transmitter unit 1 and in the receiver 2 to be advanced independently of the control button 6 being operated. By way of example, this can happen on the basis of signals from the clock generator 4 for the transmitter unit 1 or from the clock generator 12 in the receiver device 2. Thus, both algorithms can be advanced after a prescribed number of clock pulses have elapsed. Another option is for the algorithm in the microprocessor 3 to be advanced more quickly than the algorithm in the receiver 2.

Since, however, there is the risk in this case that the coded information item C transmitted by the portable transmitter unit 1 may be outside the capture range of the receiver 2, it is necessary to ensure that the algorithm in the microprocessor 3 and the algorithm in the microprocessor 11 are at the same starting value after particular intervals, in order to ensure operation of the security device. For this purpose, synchronization is carried out whenever the control button 6 has been operated.

If the data transmission between the portable transmitter 1 and the receiver device 2 is now subject to interference, which is detected by virtue of the fact that the portable transmitter unit 1 does not contain a response signal B despite transmission of the stimulus signal A or else the receiver device 2 does not output an acknowledgment signal D after transmission of the coded information item C, the algorithms in the microprocessors 3 and 11 are each advanced by n steps in order to increase the security of the device, with the result that all transmitted coded information items and possibly tapped information items are certain to be in the past.

1. An apparatus for activating and/or deactivating a security device, particularly an entry device for a motor vehicle, having a portable transmitter unit for transmitting a coded information item which is received by a receiver apparatus and is compared with a prescribed coded information item, the receiver apparatus being capable of outputting an actuation signal to the security device if the two information items match, wherein, to set up a two-way data transmission link, the portable transmitter unit (1) emits a stimulus sequence (A) which, once received by the receiver device (2), is answered with an response signal (B), and, having received the response signal (B), the portable transmitter unit (1) transmits the coded information item (C).

2. The apparatus as claimed in claim 1, wherein the stimulus sequence (A), the response signal (B) and the coded information item (C) are transmitted in approximately the same frequency range.

3. The apparatus as claimed in claim 1, wherein the portable transmitter unit (1) and the receiver apparatus (2) each contain a code generator (19, 17), the first code generator (19) in the portable transmitter unit (1) generating the coded information item (C) which is to be transmitted, and the second code generator (17) in the receiver apparatus (2) generating the prescribed coded information item, both code generators (19, 17) operating on the basis of the same algorithm.

4. The apparatus as claimed in claim 3, wherein the algorithm is used for repeatedly modifying the coded information item which is to be transmitted and the prescribed coded information item.

5. The apparatus as claimed in claim 3, wherein the algorithm for modifying the coded information items which are to be transmitted and the prescribed coded information items is changed after each action by the portable transmitter unit.

6. The apparatus as claimed in claim 3, wherein the first and second code generators (19, 17) advance the coded information item which is to be transmitted and the prescribed coded information item under time control.

7. The apparatus as claimed in claim 6, wherein the clock rate for the first code generator (19) in the portable transmitter unit (1) is higher than the clock rate for the second code generator (17) in the receiver device (2).

8. The apparatus as claimed in claims 1 and 7, wherein the first and second code generators (19, 17) are set to a common value after the actuation signal is output by the receiver device (2).

9. The apparatus as claimed in claims 1 and 3, wherein, if an acknowledgment signal (D) from the receiver device (2) confirming receipt of the coded information item (C) which is to be transmitted fails to appear, the first code generator (19) in the portable transmitter unit (1) is advanced.

10. The apparatus as claimed in claims 1 and 3, wherein, if the coded information item (C) which is to be transmitted fails to appear despite transmission of the response signal (B) by the receiver apparatus (2), the second code generator (19) in the receiver apparatus (2) is advanced.

11. The apparatus as claimed in claims 9 and 10, wherein the first and second code generators (19, 17) are advanced by the same number of steps.
